(19) United States
(12) Patent Application Publication
(10) Pub. No.: US 2005/0206939 A1
(43) Pub. Date: Sep. 22, 2005

(54) Service linking processing method and device

(75) Inventors: Kenji Tsutsumi, Ebina-shi (JP); Hitoshi Tsushima, Ebina-shi (JP); Takashi Hirata, Ebina-shi (JP); Takayuki Asako, Ebina-shi (JP); Takuya Honda, Ebina-shi (JP); Yukimasa Ishida, Ebina-shi (JP); Hiroshi Yamamoto, Ebina-shi (JP); Yasuyuki Shimizu, Ebina-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/961,209

(22) Filed: Oct. 12, 2004

(30) Foreign Application Priority Data
Mar. 22, 2004 (JP) 2004-82081

(51) Int. Cl. G06F 15/00

(52) U.S. Cl. 358/1.13; 358/1.15

(57) ABSTRACT

A service processing device and service linking processing method which can execute appropriate tabulation for each of service linked processings which combine a plurality of services. It is judged whether or not individual instruction information, which is transmitted from a linking processing server, has been received, and operation stands-by until receipt. Each service processing device interprets service processing request contents described in the individual instruction information, and executes a service processing. When execution of the service processing is completed, a results log of the service processing is stored in the service processing device together with a request ID, a client ID, and billing destination information.

### CROSS-REFERENCE TO RELATED APPLICATION

This application claims priority under 35 USC 119 from Japanese Patent Application No. 2004-82081, the disclosure of which is incorporated by reference herein.

### BACKGROUND OF THE INVENTION

1. Field of the Invention

The present invention relates to a service linking processing method and device which execute a plurality of processings in a linked manner.

2. Description of the Related Art

It is known to provide a technique (called Job Flow Service (JFS)), which links together a plurality of services such as copying, scanning and storing data, fax transmission, file transfer, mail transmission, image processing, file conversion, and the like, by a program describing a combination of the services.

In accordance with the technique, tabulation is carried out for each independent service processing, such as copying, fax transmission, and the like, or for each user requesting a processing.

### SUMMARY OF THE INVENTION

The present invention proposes a setup which carries out results tabulation of service processings for each series of linked processings, and provides a service linking processing method and device which can execute appropriate tabulation for each service linked processing which combines plural services.

In accordance with an aspect of the present invention, there is provided a service processing device which manages a series of service processings at a plurality of service processing sections, the service processing device comprising: a service requesting section that requests the series of service processings on the basis of instruction information which includes contents of individual service processings structuring the series of service processings and information regarding linking of the service processings; a request ID adding section that adds a request ID for each request to the series of service processings requested by the service requesting section; a memory that stores results of the individual service processings together with the request ID; and a results outputting section that outputs, for each request ID, the results of the individual service processings stored in the memory.

In accordance with another aspect of the present invention, there is provided a service processing system which processes a series of service comprising: a plurality of service processing sections that executes the individual service processing; a service requesting section that requests the series of service processings on the basis of instruction information which includes contents of individual service processings structuring the series of service processings and information regarding linking of the service processings; a request ID adding section that adds a request ID for each request to the series of service processings requested by the service requesting section; a memory that stores results of the individual service processings together with the request ID; a results outputting section that outputs, for each request ID, the results of the individual service processings stored in the memory.

In accordance with yet another aspect of the present invention, there is provided a service linking processing method which processes a series of service processings at a plurality of service processing sections, the service linking processing method comprising: requesting the series of service processings on the basis of instruction information which includes contents of individual service processings structuring the series of service processings and information regarding linking of the service processings; adding a request ID for each request to the requested series of service processings; storing results of the individual service processings together with the request ID; and outputting, for each request ID, the stored results of the individual service processings.

In accordance with further aspect of the present invention, there is provided a service processing program making a computer function such that a series of service processings are processed at a plurality of service processing sections, wherein the service processing program makes the computer function so as to: request the series of service processings on the basis of instruction information which includes contents of individual service processings structuring the series of service processings and information regarding linking of the service processings; add a request ID for each request to the requested series of service processings; store results of the individual service processings together with the request ID; and output, for each request ID, the stored results of the individual service processings.

### BRIEF DESCRIPTION OF THE DRAWINGS

Embodiments of the invention will be described in detailed based on the following figures, wherein:

FIG. 1 is a block diagram showing the structure of a service linking processing system relating to a first embodiment;

FIG. 2 is a block diagram for explaining interrelationships among respective service processing devices structuring the service linking processing system of the first embodiment;

FIG. 3 is a drawing showing the structure of I/F information;

FIG. 4 is a fee table stored in a fee managing device;

FIG. 5 is a diagram showing an instruction preparing screen which is a GUI screen for defining a job flow;

FIGS. 6A and 6B are drawings showing instructions;

FIG. 7 is a block diagram showing the structure of a linking processing server;

FIG. 8 is a flowchart showing the order of processing of a terminal and an instruction generating server at the time of preparing an instruction;

FIG. 9 is a flowchart showing the order of service request processing by the linking processing server;

FIG. 10 is a flowchart showing the order of an individual service processing of the first embodiment;

FIG. 11 is an example of a results log recorded in a service processing device;

FIG. 12 is a flowchart of service after-processing carried out by the linking processing server;

FIG. 13 is an example of a results log recorded in the linking processing server;

FIG. 14 is a flowchart showing the order of tabulation processing in the fee managing device of the first embodiment;

FIG. 15 is an example of results output at the fee managing device;

FIG. 16 is a block diagram for explaining interrelationships among respective service processing devices structuring a service linking processing system of a second embodiment;

FIG. 17 is a flowchart showing the order of individual service processing of the second embodiment; and

FIG. 18 is a flowchart showing the order of tabulation processing at a fee managing device of the second embodiment.

### DETAILED DESCRIPTION OF THE INVENTION

Embodiments of the present invention will be described in detail hereinafter with reference to the drawings.

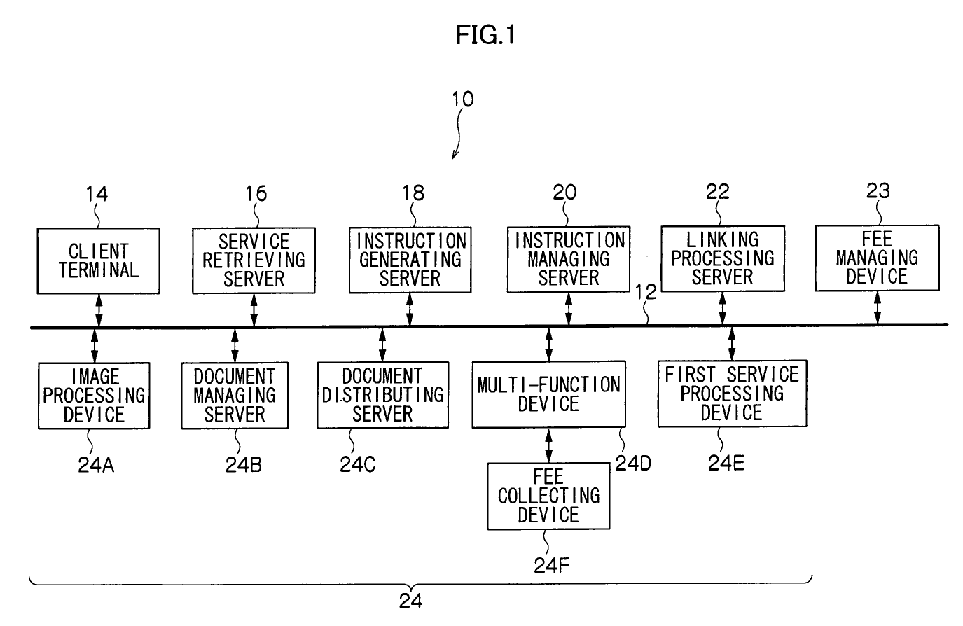

A service linking processing system (hereinafter, “system”) 10 relating to a first embodiment of the present invention and shown in FIG. 1, is a structure in which various services and applications are connected via a network 12.

Here, “service” means a function which can be used in relation to a document in accordance with a request from the exterior. Services include, for example, copying, printing, scanning, fax receipt and transmission, mail distribution, storage into a repository and reading from a repository, OCR (Optical Character Recognition) processing, noise removal processing, translation, image processing (sepia to color, sharpness conversion, color conversion, image enhancement, and the like), file format conversion, and the like, but are not limited to these examples.

Specifically, the system 10 includes a client terminal (hereinafter, “terminal”) 14 having a user interface which links plural services and instructs a desired processing of the user; a service retrieving server 16 retrieving the services desired by the user; an instruction generating server 18 preparing an instruction (details of instructions will be described later) from information which relates to service linkage and which is instructed at the terminal 14; an instruction managing server 20 which manages instructions; a linking processing server 22 executing linking processing of respective services in accordance with an instruction; and a fee managing device 23 carrying out fee management for the respective services.

Here, an “instruction” means data which, when a series of processings are disassembled into a plurality of functional processings, includes information expressing the relationships of the respective functions, interface information (I/F information) for calling-up the respective functions, and information for structuring a graphical user interface (GUI) relating to the series of processings. Further, “linking” means relationships among services for carrying out a series of processings by a plurality of the services. Examples include the results of a given service determining the contents of services to be started thereafter, or the results of a given service being used as the input of the next service, and the like.

The system 10 includes service processing devices 24 carrying out individual processings for executing various services. The service processing device 24 includes an image processing device 24A carrying out image processings such as noise removal processing or image rotating processing of an image document, OCR processing, binding of an image, and the like; a document managing server 24B which manages documents; a document distributing server 24C which distributes documents; a multi-function device 24D having the plural functions of a fax machine, a printer, a scanner, and the like; and a first service processing device 24E carrying out a first service processing.

In the present embodiment, the system 10 is structured such that a plurality of servers which carry out predetermined service processings are connected via the network 12. However, the system 10 may be structured as a service linking processing device in which a plurality of services can be implemented within a single device.

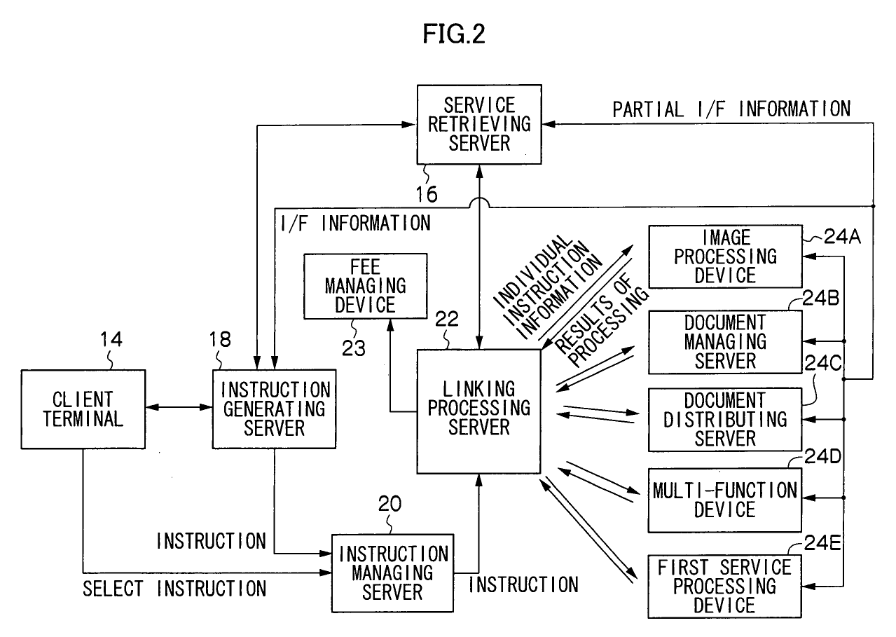

FIG. 2 is a block diagram for explaining the interrelationships among the respective service processing devices 24 structuring the system 10. Each service processing device 24 stores I/F information which expresses the contents of the service which that service processing device 24 offers.

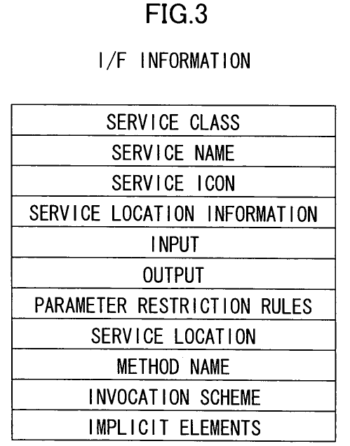

FIG. 3 is a schematic diagram showing the structure of the I/F information. The I/F information is structured by “Service Class”, “Service Name”, “Service Icon”, “Service Location Information”, “Input”, “Output”, “Parameter Restriction Rules”, “Service Location”, “Method Name”, “Invocation Scheme”, and “Implicit Elements”.

“Service Class” is the type of service which the service processing device 24 provides. Items defined in advance are used for the “Service Class”, and, for example, scanning, printing, repository, flow, and the like correspond thereto. “Service Name” is the name of the service which the service processing device 24 provides. “Service Icon” is position information of the icon displayed on the GUI of the terminal 14.

“Service Location Information” is the URL which the instruction generating server 18 uses to acquire the I/F information. “Input” is input to the service. “Output” is output from the service. “Parameter Restriction Rules” are restriction rules applied to “Input” and “Output”. “Service Location” is position information at the time when the service is actually used. “Method Name” describes the technique for offering the service processing and the name indicating the service.

“Invocation Scheme” is the method for calling-up and starting-up the service processing. For example, SOAP (Simple Object Access Protocol), SMTP (Simple Mail Transfer Protocol), and the like which are protocols for message exchange, may be used as the “Invocation Scheme”. “Implicit Elements” is not data which is clearly transferred to a processing thereafter as output, but is data which can be referred to in the processing thereafter.

In order to instruct preparation of an instruction and to select an instruction which is to be started, the terminal 14 is provided with a graphical user interface (GUI) function for displaying a screen and carrying out predetermined operations. Each terminal 14 has a client ID and billing destination information. The client ID is a particular ID given to each individual terminal 14. The billing destination information is the billing destination of the fees for the service processings requested from each terminal 14, and is determined in advance and registered.

When retrieval conditions are transmitted from the instruction generating server 18 or the linking processing server 22, the service retrieving server 16 retrieves the services by using partial I/F information of each service processing device 24. The service retrieving service 16 stores in advance portions of the I/F information (hereinafter called “partial I/F information”) of various service processing devices such as the image processing device 24A, the document managing server 24B, the document distributing server 24C, the multi-function device 24D, the first service processing device 24E, and the like.

Here, the partial I/F information means the “Service Class”, “Service Name”, “Service Location Information”, “Input” information, and “Output” information among the elements of the I/F information. For example, when the service retrieving server 16 retrieves a service which is similar to a predetermined service, it suffices for the service retrieving server 16 to retrieve a service whose “Service Class” matches, or retrieve a service whose “Input” and “Output” match, or retrieve a service at which all of these match.

When retrieval conditions are transmitted from the instruction generating server 18 or the linking processing server 22, the service retrieving server 16 retrieves a service by using the partial I/F information of the respective service processing devices. For example, when the service retrieving server 16 retrieves a service which is similar to a predetermined service, it suffices for the service retrieving server 16 to retrieve a service whose “Service Class” matches, or retrieve a service whose “Input” and “Output” match, or retrieve a service at which all of these match.

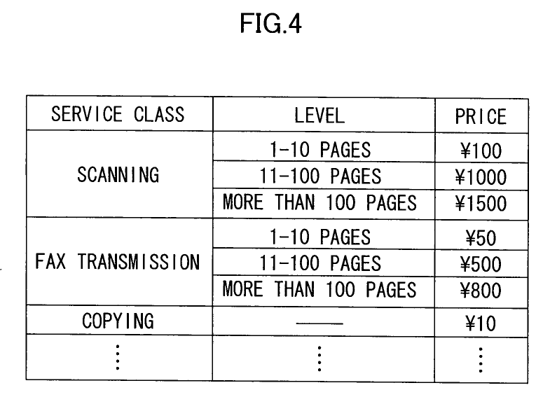

As shown in FIG. 4, a fee table showing the service unit price for each “Service Class” is stored in the fee managing device 23. Among the service unit prices, there are those for which levels have been defined. For those services for which levels have been defined, the amounts of the prices which differ in accordance with volume, such as the number of sheets in a document, the number of converted characters, and the like, are stored. By changing the stored unit prices of the services upon occasion as the fees are revised, collection of fees which reflects the fees of the respective services which fluctuate in real time can be carried out. Further, the fee managing device 23 executes tabulation for the service processings periodically (e.g., every month).

When the instruction generating server 18 generates an instruction, the instruction generating server 18 acquires I/F information from the respective service processing devices 24, and generates an instruction for linking the services which the respective service processing devices 24 offer. In order to prepare the instruction, the instruction generating server 18 carries out the following processings specifically.

On the basis of the “Service Location Information”, the instruction generating server 18 requests transmission of the I/F information relating to the respective services, from predetermined service processing devices 24 which are dispersed on the network 12. Note that, in a case in which there are no predetermined service processing devices 24, the following may be carried out: the instruction generating server 18 instructs the service retrieving server 16 to retrieve other service processing devices 24 which carry out the same processings as the predetermined service processing devices 24. Then, the instruction generating server 18 acquires the “Service Location Information” of these other service processing devices 24 from the service retrieving server 16.

The instruction generating server 18 manages the results of retrieval from the service retrieving server 16 or the I/F information received from the respective service processing devices 24. On the basis of the I/F information acquired from the service processing devices 24, the instruction generating server 18 generates an HTML file which becomes a GUI screen for defining the job flow. Then, when there is a request from the terminal 14 or the multi-function device 24D to browse the services, the instruction generating server 18 transmits the HTML file which becomes the GUI screen to the terminal 14 or the multi-function device 24D which had the request.

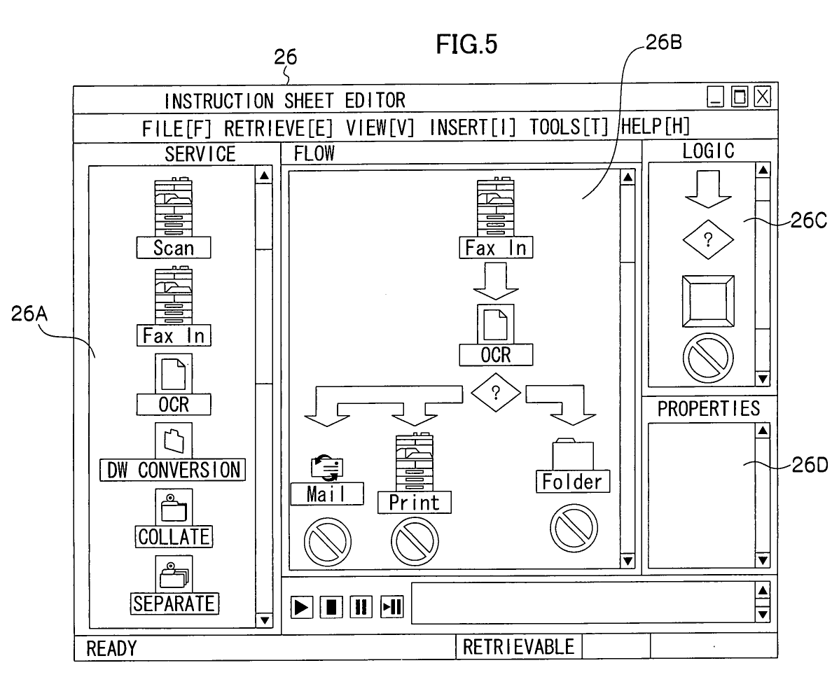

FIG. 5 shows an instruction preparing screen 26 which is a GUI screen for defining the job flow. The instruction preparing screen 26 includes a service window 26A, a flow window 26B, a logic window 26C, and a property window 26D.

The service window 26A displays the various service processing devices 24 which can be used. The logic window 26C displays the job flow showing the pattern of the linking between the services. The property window 26D displays detailed setting parameters of the respective icons displayed in the service window 26A and the logic window 26C.

The user can define the job flow in the flow window 26B by dragging-and-dropping icons of the service window 26A and icons of the logic window 26C into the flow window 26B. Further, by editing the contents displayed in the property window 26D, the user can set in detail the services and the relationships between the services such as the logics or the like.

The terminal 14 transmits, to the instruction generating server 18, the job flow information defined by the operation of the user.

On the basis of the job flow information relating to the instruction of service linkage from the user and on the basis of the I/F information of the respective services, the instruction generating server 18 prepares an instruction which defines the contents of the processings requested of the respective services, the input parameters, the way of linking the services (the job flow), and information for specifying the document which is the object of processing, such as the document name or storage location information or the like.

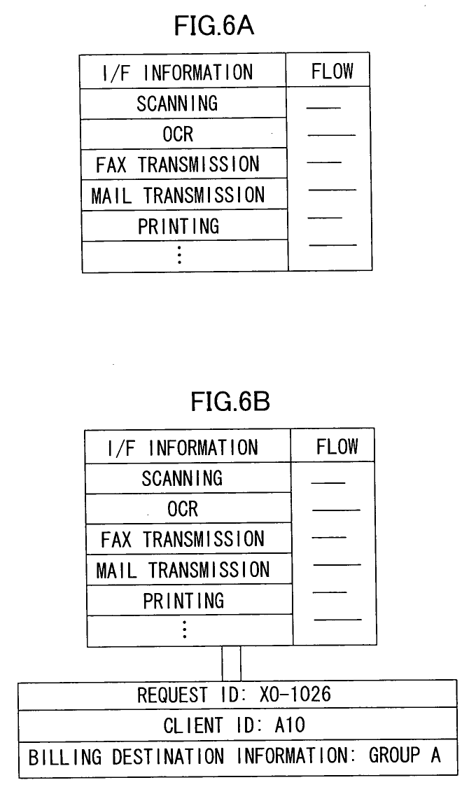

FIG. 6A is a schematic diagram showing an instruction. The I/F information of the corresponding services (see FIG. 4) and “Flow” information relating to the overall linking processing of the services, are given in the instruction.

“Flow” is elements describing the linking of the services, and includes “Invoke”, elements such as “I/F” and the like for the control structure and logic computation and condition judgment, operation instructions for adjusting the links between the services, information for specifying the document which is the object of processing, and the like.

“Invoke” expresses the specific method of the service processing device 24, and executes calling-up of the service. The elements of “Invoke” are “Map”, which expresses the position information of the parameters, and “Method”, which is the name of the method to be called-up. “I/F”, “and”, “eq”, and “gt”, which express the control structure, the logic computation, and the like, carry out the branching of conditions at the time of linking processing, and execute adjustment of parameters which are transferred and received among the services.

The instruction generating server 18 transmits an instruction such as described above to the instruction managing server 20. In a case in which execution of service linking processing is instructed by the user, the instruction generating server 18 may transmit the instruction directly to the linking processing server 22.

The instruction managing server 20 holds the instruction transmitted from the instruction generating server 18, and transmits the instruction to the linking processing server 22 in accordance with a request from the terminal 14.

The linking processing server 22 interprets and executes the designated instruction. When the linking processing server 22 executes the instruction, first, it adds, to the instruction, a unique request ID for each request for execution. The request ID is prepared on the basis of the execution start time and the ID particular to the linking processing server 22 which requests execution of the instruction. Further, the client ID of the terminal 14 which requested execution of the instruction, and the billing destination information are also added thereto (see FIG. 6B).

The linking processing server 22 interprets the instruction, and in accordance with the order and the method of use described in the instruction, calls-up in order the service processing devices 24 such as the image processing device 24A, the document managing server 24B, the document distributing server 24C and the like, and executes the linking processing.

Further, the linking processing server 22 stores, together with the request ID, the client ID, and the billing destination information, information regarding the status of the linking processing currently being executed or the results of the linking processing which has been completed, and transmits the status or the results of the linking processing in response to a request therefor from the exterior.

When the linking processing server 22 interprets the instruction and requests the processings to the service processing devices 24, the linking processing server 22 prepares individual instruction information having processing request contents, input parameters, information for specifying the document which is the object of processing, the job flow (service linkage) in accordance with the instruction, and the like. Note that the linking processing server 22 may extract information related to the service processings in the linked processings which are before and after the processing carried out at each service processing device 24, and describe that information in the instruction. Or, the linking processing server 22 may carry out the processing request not in the format of the instruction, but rather in information exchange formats particular to each of the service processing devices 24.

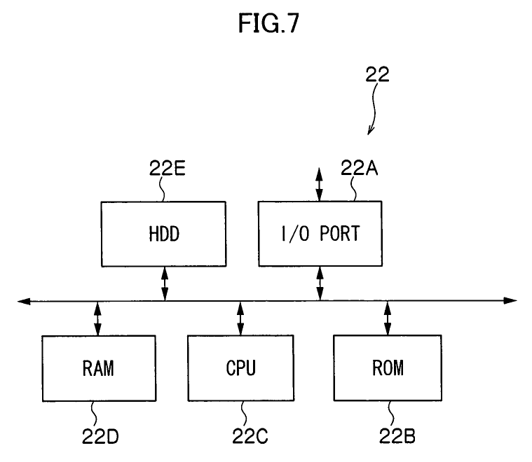

FIG. 7 is a block diagram showing the structure of the linking processing server 22. The linking processing server 22 has an input/output (I/O) port 22A carrying out transmission and receipt of information with the network 12, a ROM 22B which stores a linking processing control program, a CPU 22C executing the linking processing, a RAM 22D which is a data work area, and a hard disk drive 22E storing data and the like processed by the CPU 22C.

The input/output port 22A, for example, receives the instruction, transmits the individual instruction information for requesting service processings to the service processing devices, and receives processing results logs from the service processing devices.

The CPU 22C executes overall control of the linking processing server 22. For example, the CPU 22C prepares the individual instruction information for the respective service processing devices on the basis of the instruction, and records the logs of the processing results from the respective service processing devices in the hard disk drive 22E.

The image processing device 24A can be structured by a computer in which is installed a software program for carrying out image processing functions. The image processing device 24A carries out processing of the document on the basis of the service processing request contents, the input parameters, and the information regarding the document which is the object of processing, which are included in the processing request from the linking processing server 22. Further, at the time of startup, the image processing device 24A notifies the service retrieving server 16 of the partial I/F information. Moreover, in accordance with a request from the instruction generating server 18, the image processing device 24A transmits I/F information showing the method of using the image processing service. This I/F information is used at the time of preparing the instruction.

The document managing server 24B has a document storing function. On the basis of information included in the request from the linking processing server 22, the document managing server 24B stores, retrieves, or reads-out the document, and changes the attributes relating to the document and executes various types of processings. Further, at the time of startup, the document managing server 24B informs the service retrieving server 16 of the partial I/F information. Moreover, in accordance with a request from the instruction generating server 18, the document managing server 24B transmits the I/F information expressing the way of using the document managing service.

The document distributing server 24C has the functions of storing an acquired document in a designated document managing server, carrying out mail transmission or fax transmission to a designated transmission destination, and carrying out printing output processing at a designated printer. In accordance with a request from the linking processing server 22, the document distributing server 24C carries out document distribution processing on the basis of the document designated by the terminal 14 and the distribution destination information thereof. Further, at the time of startup, the document distributing server 24C informs the service retrieving server 16 of the partial I/F information. In addition, in accordance with a request from the instruction generating server 18, the document distributing server 24C transmits I/F information expressing the method of use of the distributing processing service.

The multi-function device 24D has an image reading function of reading a paper document and preparing an electronic image document, and the functions of printing and faxing the acquired document. On the basis of information from the linking processing server 22 such as the processing request contents, the input parameters, the information for specifying the document which is the object of processing, and the like, the multi-function device 24D executes the service processing which is to be carried out at the multi-function device 24D, such as fax transmitting or printing processing or the like. Further, at the time of startup, the multi-function device 24D informs the service retrieving server 16 of the partial I/F information. Moreover, in accordance with a request from the instruction generating server 18, the multi-function device 24D transmits I/F information expressing the method of use of the service processing. The multi-function device 24D can be structured by a fax machine which is connected by a public line network.

The first service processing device 24E carries out a predetermined service processing relating to the document, in accordance with an instruction from the exterior. On the basis of information from the linking processing server 22 such as the processing request contents, the input parameters, the information for specifying the document which is the object of processing, and the like, the first service processing device 24E executes the service processing which is to be executed at the first service processing device 24E. Further, at the time of startup, the first service processing device 24E notifies the service retrieving server 16 of the partial I/F information. Moreover, in accordance with a request from the instruction generating server 18, the first service processing device 24E transmits I/F information expressing the method of use of the service processing.

In the system 10 which is structured as described above, application programs for executing respective predetermined services are installed in the respective service processing devices 24 such as the image processing device 24A, the document managing server 24B, the document distributing server 24C, and the like, and operate as follows.

At the time of startup processing, the respective service processing devices 24, i.e., the image processing device 24A, the document managing server 24B, the document distributing server 24C, the multi-function device 24D, the first service processing device 24E, and the like inform the service retrieving server 16 of their partial I/F information including summaries of the respective services and information expressing the addresses.

The service retrieving server 16 stores the partial I/F information transmitted from the respective service processing devices 24, i.e., the image processing device 24A, the document managing server 24B, the document distributing server 24C, the multifunction device 24D, the first service processing device 24E, and the like. In this way, when, for example, there is a request for retrieval of a predetermined service from the instruction generating server 18 or the linking processing server 22, the service retrieving server 16 can carry out retrieval by using the partial I/F information.

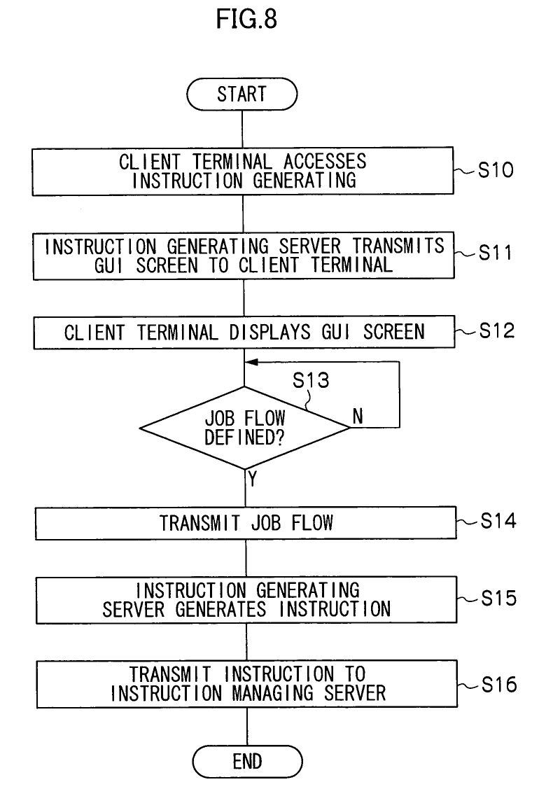

The flowchart in FIG. 8 shows the order of processings of the terminal 14 and the instruction generating server 18 at the time of preparing an instruction.

In accordance with operation of the user and through an (installed) browser, the terminal 14 accesses the URL (Uniform Resource Locator) of the HTML file generated for use for the user interface screen offered by the instruction generating server 18 (step S10).

In accordance with a browse request from the terminal 14, the instruction generating server 18 transmits the HTML file of the GUI screen to the terminal 14 which is the source of the request (step S11).

On the basis of the information, which is transmitted from the instruction generating server 18 and which is included in an HTML file for example and which structures the screen, the terminal 14 which is the source of the request displays the user interface screen (step S12). At this time, the user can define the job flow of the desired service linkage by using the GUI screen displayed at the terminal 14.

The terminal 14 judges whether or not the job flow has been defined via the GUI screen, and stands-by until the job flow is defined (step S13). When the terminal 14 judges that the job flow has been prepared, the terminal 14 transmits, to the instruction generating server 18, job flow information relating to the service linkage defined by the user (step S14).

On the basis of the information relating to the job flow of the service linkage transmitted from the terminal 14, and the I/F information acquired from the respective service processing devices 24, the instruction generating server 18 prepares an instruction which defines the contents of the processings requested of the respective services, the input parameters, the way of linking the respective services, the document name, storage location information, information for specifying the document which is the object of processing, and the like (step S15). The instruction generating server 18 transmits the instruction to the instruction managing server 20 (step S16). The instruction managing server 20 receives and stores the instruction generated at the instruction generating server 18.

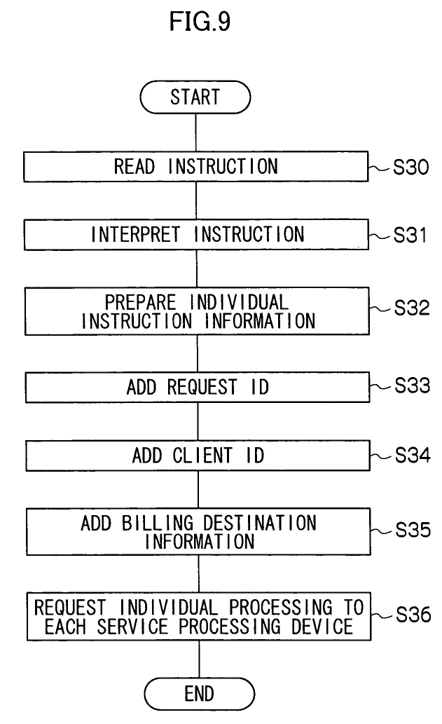

When execution of the instruction is inputted from the terminal 14, the linking processing server 22 carries out the service requesting processing shown in FIG. 9. First, the linking processing server 22 reads-out the instruction from the instruction managing server 20 (step S30). Next, the linking processing server 22 interprets the read-out instruction (step S31), and on the basis of the contents of the instruction, prepares individual instruction information for requesting execution at the respective service processing devices 24 (step S32). The linking processing server 22 adds, to both the instruction and the individual instruction information, the request ID (step S33), the client ID (step S34), and the billing destination information (step S35). Then, on the basis of the individual instruction information, the linking processing server 22 requests the service processing devices 24 to execute the respective individual processings in the order in accordance with the instruction (step S36).

In accordance with this service requesting processing, a particular request ID is added to the series of service processings based on the instruction.

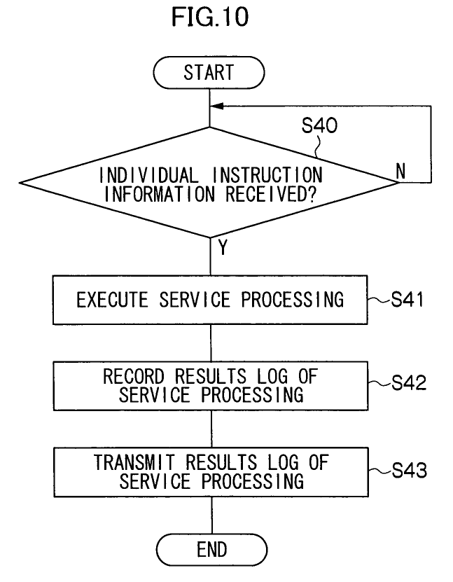

Hereinafter, with reference to the flowchart in FIG. 10, description will be given of the individual service processings carried out at the respective service processing devices 24.

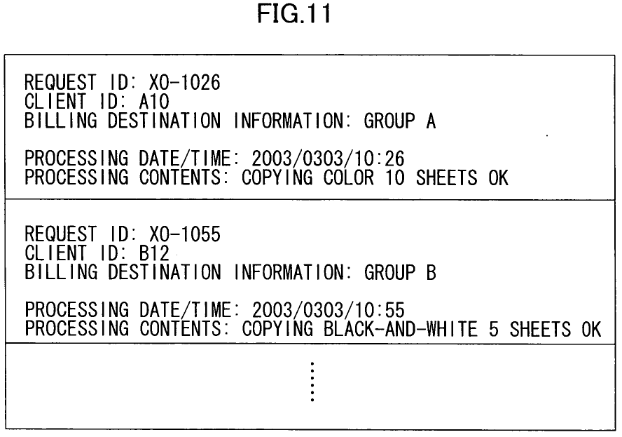

First, each of the service processing devices 24 judges whether or not the individual instruction information transmitted from the linking processing server 22 has been received, and stands-by until the individual instruction information is received (step S40). Each service processing device 24 interprets the service processing request contents described in the individual instruction information, and executes the service processing (step S41). After execution of the service processing has been completed, a results log of the service processing is recorded in the service processing device 24 together with the request ID, the client ID, and the billing destination information (step S42). An example of the results log at each service processing device 24 is shown in FIG. 11. Then, the results log of the service processing is transmitted to the linking processing server 22 together with the request ID, the client information, and the billing destination information (step S43).

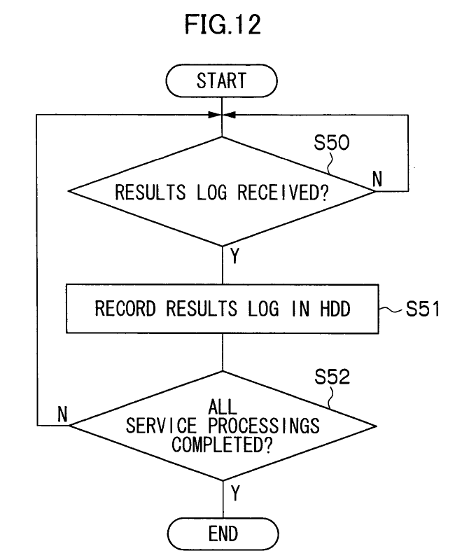

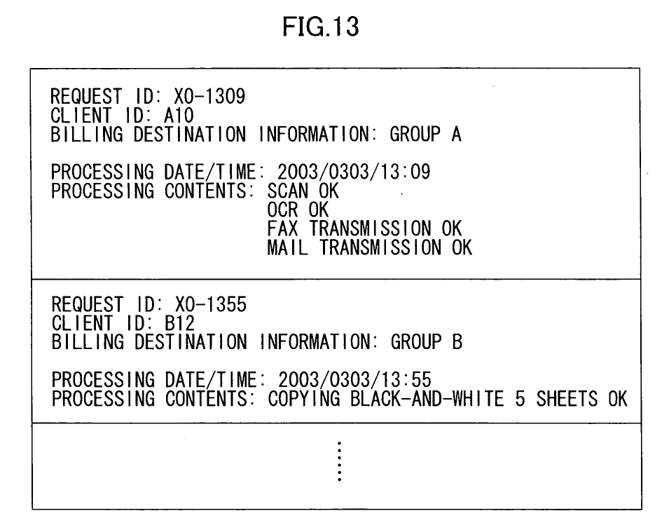

At the linking processing server 22, after a request to execute an individual processing has been given to the service processing device 24, the service after-processing shown in FIG. 12 is carried out. The linking processing server 22 stands by until it receives the results log from the service processing device 24 (step S50). When the linking processing server 22 receives the results log, it records the results log in the hard disk drive 22E (step S51). Then, the linking processing server 22 judges whether or not all of the service processings stated in the instruction have been completed (step S52). If the judgment is negative, the routine returns to step S50 where the linking processing server 22 stands by until it receives the next results log. If the judgment is affirmative, the present processing ends. An example of results logs recorded in the related processing server 22 is shown in FIG. 13.

In accordance with the above-described individual service processings and the service after-processings, a results log for each request can be recorded in each service processing device 24 and in the linking processing server 22.

Next, tabulation of the service processings executed in the system 10 will be described.

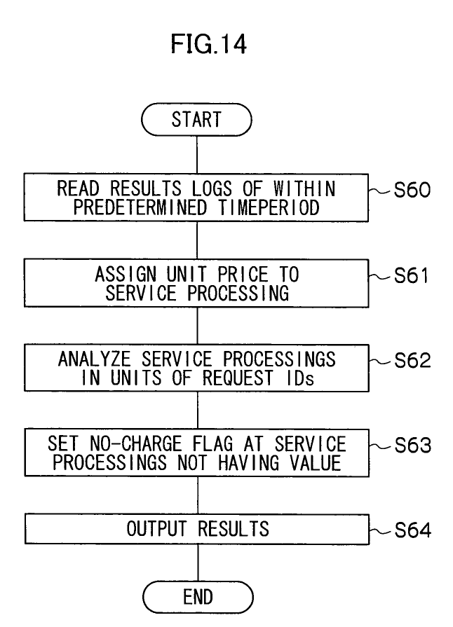

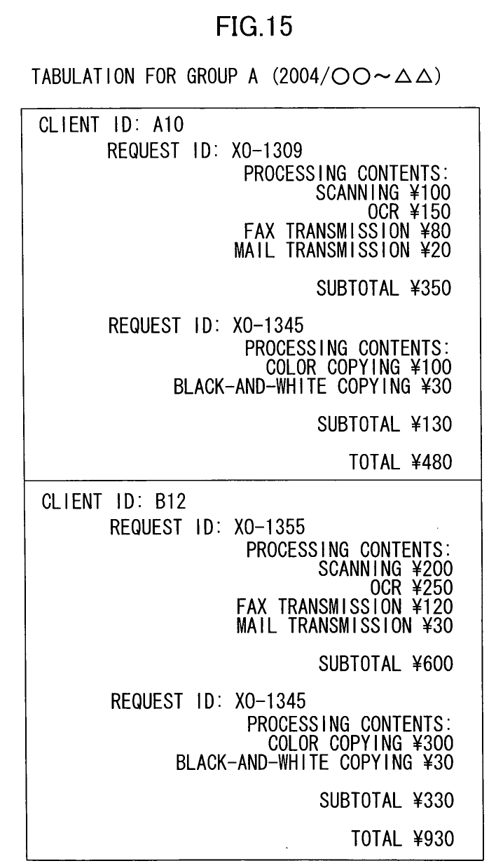

At the fee managing device 23, the tabulation processing shown in FIG. 14 is carried out periodically. First, the results logs of service processings within a predetermined time period and recorded in the linking processing server 22 are read-out (step S60). Next, on the basis of a fee table stored in the fee managing device 23, a unit price is applied to each of the service processings described in the results logs which have been read-out (step S61). Then, the respective service processings are analyzed in units of their request IDs (step S62). This analysis is for judging, in a case in which, for example, a series of service processings ended while in the midst of being executed, whether or not charging should be carried out for the service processings which have been completed among a series of service processings which ended in the midst of execution. For example, for the two service processings of scan→fax transmission, when it is judged that the scanning has been completed but the fax transmission has not yet been finished, it is judged that there is no value merely in the processing of scanning, and charging is not carried out. After the analysis in step S62, a no-charge flag is set (step S63) for those service processings judged to have been completed normally but to not have value. Then, for each of the billing destination in formations, the results of the service processings at the respective terminals 14 are outputted (step S64). At this time, if a no-charge flag is set, the fee for that service processing is outputted as 0 (zero). An example of results outputting which is carried out in the form of for each billing destination information is shown in FIG. 15.

In accordance with the present processing, tabulation of service processings can be carried out for each billing destination information, and for each request ID. Further, it is judged whether an executed service processing has value, and if it is judged to not have value, that service processing is not made to be an object of charging. Thus, appropriate charging for service processings can be carried out.

A second embodiment of the present invention will be described. Regions and parts which are the same as those of the first embodiment are denoted by the same reference numerals, and repeat description will be omitted appropriately.

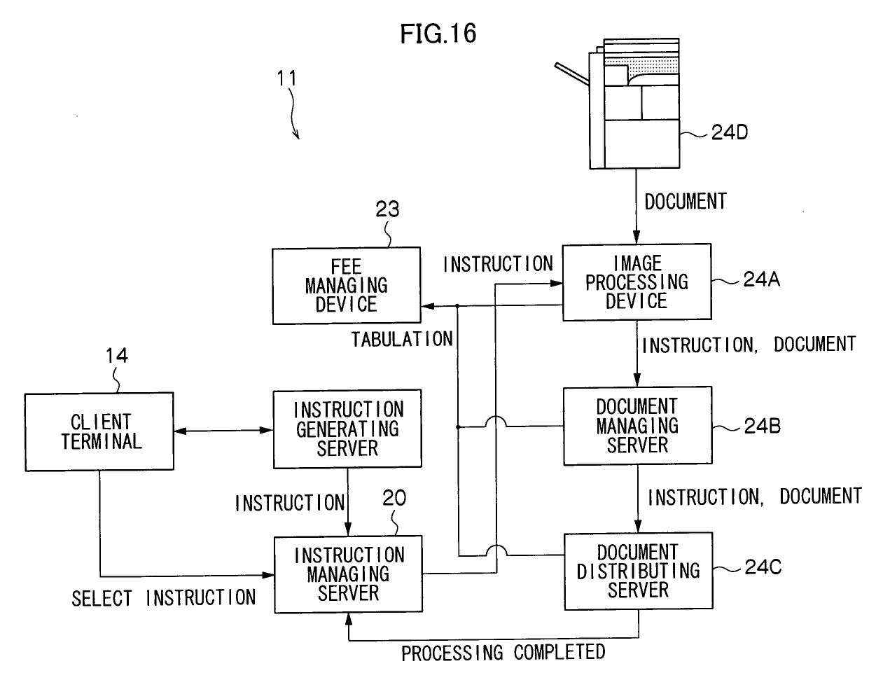

FIG. 16 is a block diagram for explaining interrelationships among respective service processing devices structuring a service linking processing system (hereinafter, “system”) 11 of the second embodiment. The system 11 can execute linking processing of a plurality of services, without using the linking processing server 22 of the first embodiment.

The system 11 has the respective service processing devices 24 of the first embodiment, but in FIG. 16, illustration of the first service processing device 24E is omitted for convenience.

Due to the user selecting services from the GUI screen of the terminal 14 and instructing execution thereof, linking processing in accordance with a desired instruction from among a plurality of instructions stored in the instruction managing server 20 can be started.

Here, explanation will be given by using, as an example, service linking processing relating to image information obtained by fax receipt or the scanner function or the like of the multi-function device 24D.

The instruction managing server 20 adds a request ID, a client ID, and billing destination information to the instruction designated by the terminal 14. Then, the instruction is first transmitted to the image processing device 24A.

The image processing device 24A acquires the document which is the object of processing from the multi-function device 24D which is the storage destination of the document which is the object of processing described in the received instruction.

The image processing device 24A interprets the service processing request contents for the acquired document image, and carries out the image processings of noise removal and OCR processing thereon, and carries out the processing of binding it with the extracted text document. After the predetermined image processings have been completed, the image processing device 24A deletes the service processing request described in the instruction. Then, the image processing device 24A transmits to the document managing server 24B (which is to carry out the next service processing), the document in which the text document and the image document obtained by the image processing are bound together, and the instruction which has the processing results such as status information of the processing (completed), output parameters, storage destination information of the document after processing, and the like.

The image processing device 24A records the results log of the individual processing in this service linking in an unillustrated memory within the image processing device 24A.

The document managing server 24B temporarily stores, in the storage destination described in the instruction, the document transmitted from the image processing device 24A. The document managing server 24B transmits the document and the instruction to the document distributing server 24C (which is to carry out the next service processing). Further, the document managing server 24B records the results log of the individual processing in this service linking in an unillustrated memory within the document managing server 24B.

On the basis of the instruction, the document distributing server 24C transmits only the text document, among the document in which the text document and the image document are bound together, to the mail address designated as the distribution destination, and faxes only the image document to the designated fax number. Then, if the document distributing server 24C judges that no next processing is described in the instruction, the document distributing server 24C informs the terminal 14 which is the source of the instruction that all of the processings have been completed, and records the results log of the individual processing in this service linking in a memory (not illustrated) of the document distributing server 24C.

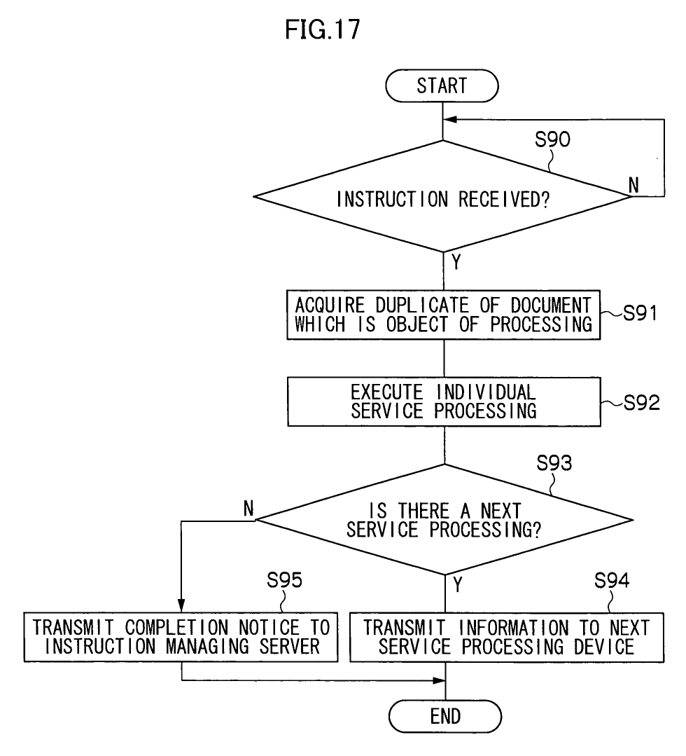

Hereinafter, the individual service processing carried out at each service processing device 24 of the system 11 relating to the second embodiment will be described with reference to the flowchart of FIG. 17.

At each service processing device 24, first, it is judged whether or not an instruction has been received, and the service processing device 24 stands-by until an instruction is received (step S90). On the basis of the storage destination location information of the document which is the object of processing described in the instruction, the service processing device 24 makes a duplicate of the document which is the object of processing and acquires the document (step S91). Note that, in the present embodiment, the instruction is transmitted from the instruction managing server 20, in the order of the image processing device 24A, the document managing server 24B, and the document distributing server 24C. However, a structure is possible in which the instruction is transmitted from the multi-function device 24D to the service processing device 24 which will carry out the first individual processing in the service linking, and is transmitted successively to the respective service processing devices 24.

For the acquired document, each service processing device 24 interprets the service processing request contents described in the instruction, and carries out service processing (step S92), and judges whether or not a next linked processing is described in the instruction (step S93).

If a next linked processing is described, the instruction together with the necessary information are transmitted (step S94) to the service processing device 24 which is to carry out the next service, and the present processing ends. If no next linked processing is described, the instruction managing server 20 is informed that the series of service processings has been completed (step S95), and the present processing ends.

Next, description will be given of the tabulation of the service processings executed at the system 11.

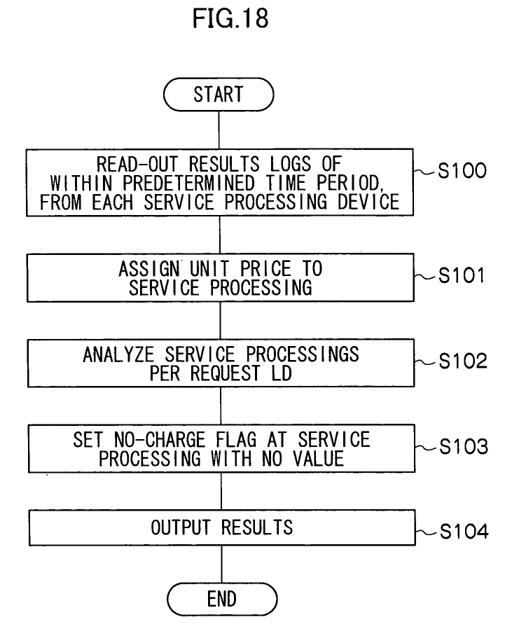

In the fee managing device 23, the tabulation processing shown in FIG. 18 is carried out periodically. First, the results logs of the service processings within a predetermined time period and recorded in the respective service processing devices 24 are readout (step S100). Next, on the basis of the fee table stored in the fee managing device 23, a unit price is applied to each service processing (step S101). Then, the respective service processings are analyzed in units of their request IDs (step S102). This analysis is the same as that described in the first embodiment. After the analysis of step S102, no-charge flags are set (step S103) for those service processings judged to not have value. Then, for each billing destination information, the results of the service processings at the respective terminals 14 are outputted (step S104). If a no-charge flag is set, the fee for that service processing is outputted as 0 (zero). An example of results output carried out in the form of for each billing destination information is the same as that shown in FIG. 15.

In accordance with the present embodiment, in the same way as in the first embodiment, tabulation of service processings can be carried out per billing destination information and per request ID. Further, it can be judged whether or not an executed service processing has a value, and the service processing is not made to be an object of charging when it is judged to not have value. Therefore, appropriate charging for service processings can be carried out.

1. A service processing device which manages a series of service processings at a plurality of service processing sections, the service processing device comprising:
a service requesting section that requests the series of service processings on the basis of instruction information which includes contents of individual service processings structuring the series of service processings and information regarding linking of the service processings;
a request ID adding section that adds a request ID for each request to the series of service processings requested by the service requesting section;
a memory that stores results of the individual service processings together with the request ID; and
a results outputting section that outputs, for each request ID, the results of the individual service processings stored in the memory.

2. A service processing system which processes a series of service comprising:
a plurality of service processing sections that executes the individual service processing;
a service requesting section that requests the series of service processings on the basis of instruction information which includes contents of individual service processings structuring the series of service processings and information regarding linking of the service processings;
a request ID adding section that adds a request ID for each request to the series of service processings requested by the service requesting section;
a memory that stores results of the individual service processings together with the request ID;
a results outputting section that outputs, for each request ID, the results of the individual service processings stored in the memory.

3. The service processing system of claim 2 wherein the memory is provided at each of the plurality of service processing sections, and the service processing system further comprises a results acquiring section that acquires the results of the individual service processings stored in the memory.

4. The service processing device of claim 1, further comprising a fee managing section that stores service fees corresponding to the individual service processings, and which tabulates a fee of the series of service processings on the basis of the results of the individual service processings acquired by the results acquiring section and the service fees corresponding to the service processings.

5. The service processing system of claim 2, further comprising a fee managing section that stores service fees corresponding to the individual service processings, and which tabulates a fee of the series of service processings on the basis of the results of the individual service processings acquired by the results acquiring section and the service fees corresponding to the service processings.

6. The service processing device of claim 1, wherein the instruction information is structured so as to include billing destination information relating to a fee billing destination of the series of service processings,
the memory stores the billing destination information together with the results of the individual service processings,
the results acquiring section acquires the billing destination information together with the results of the individual service processings, and
the fee managing section tabulates the fee of the series of service processings for each billing destination information.

7. The service processing system of claim 2, wherein the instruction information is structured so as to include billing destination information relating to a fee billing destination of the series of service processings,
the memory stores the billing destination information together with the results of the individual service processings,
the results acquiring section acquires the billing destination information together with the results of the individual service processings, and
the fee managing section tabulates the fee of the series of service processings for each billing destination information.

8. A service linking processing method which processes a series of service processings at a plurality of service processing sections, the service linking processing method comprising:
requesting the series of service processings on the basis of instruction information which includes contents of individual service processings structuring the series of service processings and information regarding linking of the service processings;
adding a request ID for each request to the requested series of service processings;
storing results of the individual service processings together with the request ID; and
outputting, for each request ID, the stored results of the individual service processings.

9. The service linking processing method of claim 8, wherein the results of the individual service processings and the request ID are stored in respective service processing sections which executed the individual service processings.

10. The service linking processing method of claim 9, wherein service fees corresponding to the individual service processings are stored, and a fee of the series of service processings is tabulated on the basis of the results of the individual service processings acquired by the results acquiring section and the service fees corresponding to the service processings.

11. The service linking processing method of claim 10, wherein the instruction information is structured so as to include billing destination information relating to a fee billing destination of the series of service processings,
the billing destination information is stored together with the results of the individual service processings, and
the fee of the series of service processings is tabulated for each billing destination information.

12. A service processing program making a computer function such that a series of service processings are processed at a plurality of service processing sections, wherein the service processing program makes the computer function so as to:
request the series of service processings on the basis of instruction information which includes contents of individual service processings structuring the series of service processings and information regarding linking of the service processings;
add a request ID for each request to the requested series of service processings;
store results of the individual service processings together with the request ID; and
output, for each request ID, the stored results of the individual service processings.

13. The service processing program of claim 12, wherein the program makes the computer function so that the results of the individual service processings and the request ID are stored in the respective service processing sections which executed the individual service processings.

14. The service linking processing program of claim 13, wherein the program makes the computer function so that service fees corresponding to the individual service processings are stored, and a fee of the series of service processings is tabulated on the basis of the results of the individual service processings acquired by the results acquiring section and the service fees corresponding to the service processings.

15. The service linking processing program of claim 14, wherein the program makes the computer function so that
the instruction information is structured so as to include billing destination information relating to a fee billing destination of the series of service processings,
the billing destination information is stored together with the results of the individual service processings, and
the fee of the series of service processings is tabulated for each billing destination information.
